(19) United States
(12) Patent Application Publication
(10) Pub. No.: US 2015/0005899 A1
(43) Pub. Date: Jan. 1, 2015

(54) ELECTRONIC DEVICE AND METHOD FOR CONTROLLING

(71) Applicant: Kabushiki Kaisha Toshiba, Tokyo (JP)

(72) Inventor: Hidenori WAKABAYASHI, Ome-shi (JP)

(21) Appl. No.: 13/929,699

(22) Filed: Jun. 27, 2013

(51) Int. Cl. G05B 15/02

(52) U.S. Cl. CPC G05B 15/02
USPC 700/17

(57) ABSTRACT

According to one embodiment, an electronic device includes, control signal receiving module, control signal determining module, transfer control module and displaying control module. The control signal receiving module configured to receive control key corresponding to instruction input. The control signal determining module configured to determine that control key received by control signal receiving module is control key to connected device. The transfer control module configured to transfer control key about which control signal determining module has made determination to connected device. The displaying control module configured to output display signal which indicates that transfer control module transfers control key to connected device.

### FIELD

Embodiments described herein relate generally to an electronic device and a method for controlling the same.

### BACKGROUND

Electronic devices capable of recording and reproducing video content (streams) such as films and television programs and displaying video such as games have been widely used.

Such an electronic device is capable of transmitting a stream in compliance with standards such as High-definition Multimedia Interface (HDMI) and Mobile High-definition Link (MHL).

An electronic device (hereinafter referred to as a source apparatus or a control device) on the side that outputs a stream outputs a stream to an electronic device (hereinafter referred to as a sink apparatus or a cooperating device) on the side that receives a stream. The sink apparatus reproduces the received stream and causes the display to display the reproduced video. When the source apparatus and the sink apparatus are connected to each other via MHL, the apparatuses are capable of mutually operating and controlling each other.

When the source apparatus and the sink apparatus are connected via MHL and one of the devices, i.e., the control device (source apparatus) is operated by remote control and thereby operation of the other device, i.e., the cooperating device (sink apparatus) is controlled, however, it is unknown whether the cooperating device has received a control key (command) from the control device until a reaction (response operation) is made by the cooperating device.

When the cooperating device makes no reaction to a control key from the control device (the cooperating device is in a non-reactive state), for example, a detailed, large-scale check needs to be performed by replacing a cable, for example, in order to investigate whether the non-reactive state is caused by the control device or the cooperating device. There are cases where a similar cause needs to be investigated in connection using the current HDMI-Consumer Electronics Control (HDMI-CEC) as well.

### BRIEF DESCRIPTION OF THE SEVERAL VIEWS OF THE DRAWINGS

FIG. 1 is an exemplary diagram showing an example of a transmitting and receiving system according to an embodiment;

FIG. 2 is an exemplary diagram showing an example of a video processing apparatus according to an embodiment;

FIG. 3 is an exemplary diagram showing an example of a mobile terminal according to an embodiment;

FIG. 4 is an exemplary diagram showing an example of the transmitting and receiving system according to an embodiment;

FIG. 5 is an exemplary diagram showing an example of the transmitting and receiving system according to an embodiment;

FIG. 6A is an exemplary diagram showing an example of a transmitting and receiving process according to an embodiment;

FIG. 6B is an exemplary diagram showing an example of the transmitting and receiving process according to an embodiment;

FIG. 7 is an exemplary diagram showing an example of the transmitting and receiving process according to an embodiment;

FIG. 8 is an exemplary diagram showing an example of a remote controller according to an embodiment; and

FIG. 9 is an exemplary diagram showing an example of the transmitting and receiving process according to an embodiment.

### DETAILED DESCRIPTION

Various embodiments will be described hereinafter with reference to the accompanying drawings.

In general, according to one embodiment, an electronic device includes: a control signal receiving module, a control signal determining module, a transfer control module and a displaying control module. The control signal receiving module configured to receive a control key corresponding to an instruction input. The control signal determining module configured to determine that the control key received by the control signal receiving module is a control key to a connected device. The transfer control module configured to transfer the control key about which the control signal determining module has made determination to the connected device. The displaying control module configured to output a display signal which indicates that the transfer control module transfers the control key to the connected device.

Embodiments will now be described hereinafter in detail with reference to the accompanying drawings.

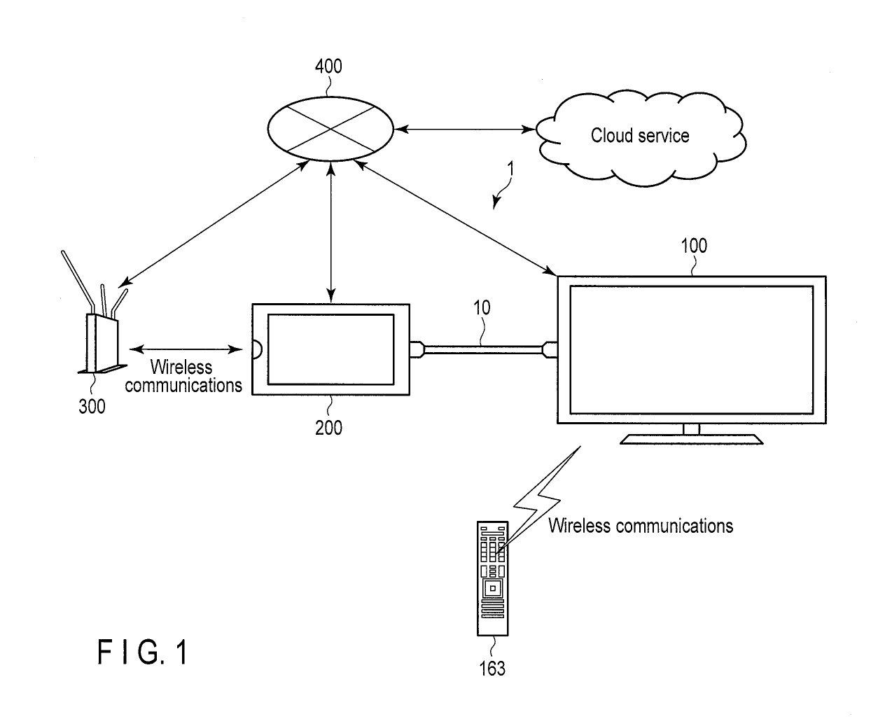

FIG. 1 is an exemplary diagram of a transmitting and receiving system according to an embodiment. Elements and configurations which will be described below may be embodied either as software or as hardware by a microcomputer (processor, central processing unit [CPU]). Content to be displayed on a monitor can be arbitrarily acquired, for example, by using space waves (electronic waves), using a cable (including optical fiber) or a network such as an Internet Protocol communication network, processing a streaming video signal from a network, or using a video transfer technique that uses a network function. Content will also be referred to as a stream, a program, or information, and includes video, speech, music, and the like. Video includes moving images, still images, texts (information expressed by characters, symbols, and the like represented by a coded string), and an arbitrary combination thereof.

A transmitting and receiving system 1 includes a video processing apparatus (source apparatus) 100, a portable terminal (sink apparatus) 200, and a wireless communication terminal 300, for example.

The control device (source apparatus) 100 is a video processing apparatus such as a broadcast receiving apparatus capable of reproducing broadcast signals or video content stored in a storage medium, for example, or a recording and reproducing device (recorder) capable of recording and reproducing content.

The cooperating device (sink apparatus) 200 is a portable terminal device (hereinafter referred to as a portable terminal), such as a portable telephone terminal, a tablet personal computer (PC), a portable music player, a handheld video game device, and the like, which includes a display, an operation module, and a communication module, for example. If the cooperating device 200 can be functioned as a sink apparatus, the cooperating device 200 may be a recorder (video recording apparatus) capable of recording and reproducing content on and from an optical disk compatible with the Blu-ray Disc (BD) standard, an optical disk compatible with the digital versatile disk (DVD) standard, or a hard disk drive (HDD), or a set-top box (STB) which receives content and supplies the content to the video processing apparatus, for example.

The wireless communication terminal 300 is capable of performing wired or wireless communications with each of the video processing apparatus 100 and the portable terminal 200. That is, the wireless communication terminal 300 functions as an access point (AP) of wireless communications. Further, the wireless communication terminal 300 is capable of connecting to a cloud service (a variety of servers), for example, via a network 400. That is, the wireless communication terminal 300 is capable of accessing the network 400 in response to a request from the video processing apparatus 100 or the portable terminal 200. Thereby, the video processing apparatus 100 and the portable terminal 200 are capable of acquiring a variety of data from a variety of servers on the network 400 (or a cloud service) via the wireless communication terminal 300.

The video processing apparatus 100 is mutually connected to the portable terminal 200 via a communication cable (hereinafter referred to as MHL cable) 10 compatible with the Mobile High-definition Link (MHL) standard. The MHL cable 10 is a cable including a High-definition Digital Multimedia Interface (HDMI) terminal having a shape compatible with the HDMI standard on one end, and a Universal Serial Bus (USB) terminal having a shape compatible with the USB standard, such as the Micro-USB standard, on the other end.

The MHL standard is an interface standard which allows users to transmit moving image data (streams) including video and moving images. According to the MHL standard, an electronic device (source apparatus) on the side that outputs stream outputs a stream to an electronic device (sink apparatus) on the side that receives a stream, via an MHL cable. The sink apparatus is capable of reproducing the received stream and causing the display to display the reproduced video. Further, the source apparatus and the sink apparatus are capable of operating and controlling each other, by transmitting a command to the counterpart apparatus connected via the MHL cable 10. That is, according to the MHL standard, control similar to the current HDMI-Consumer Electronics Control (CEC) standard can be performed.

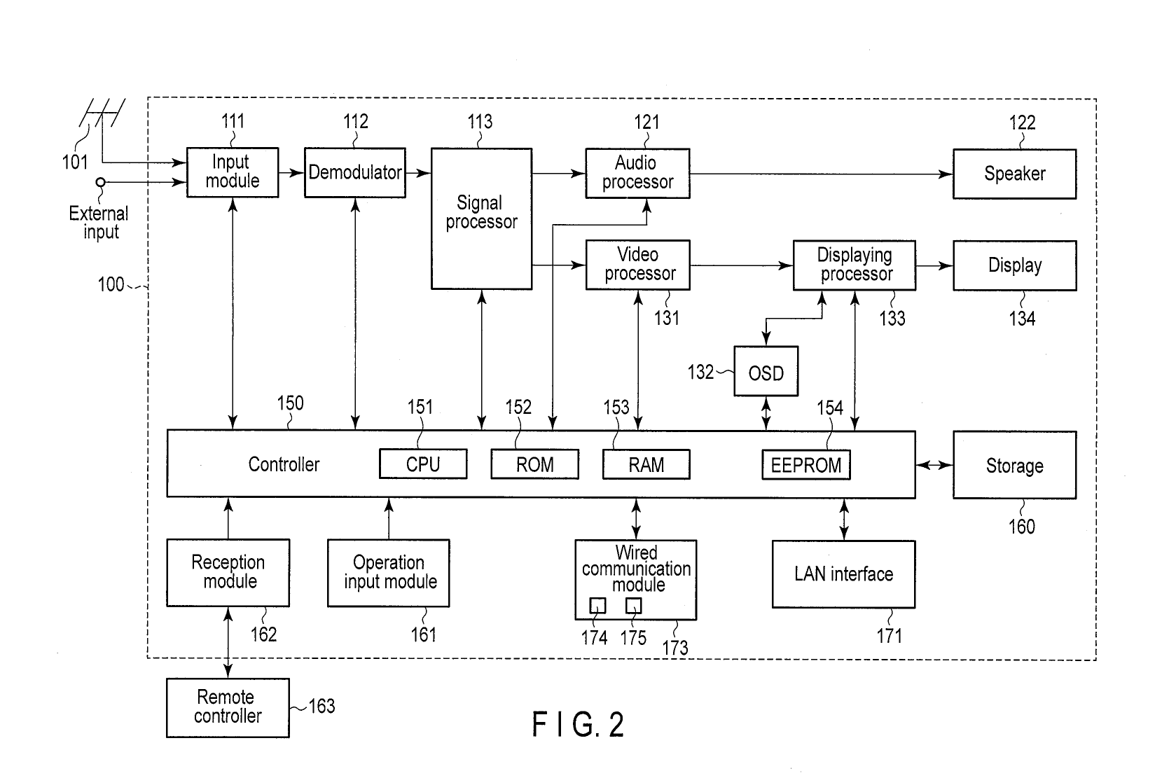

FIG. 2 shows an example of a video processing apparatus 100.

The video processing apparatus (control device) 100 comprises an input module 111, a demodulator 112, a signal processor 113, an audio processor 121, a video processor 131, an OSD processor 132, a displaying processor 133, a controller 150, a storage 160, an operation input module 161, a reception module 162, a LAN interface 171, and a wired communication module 173. The video processing apparatus 100 further comprises a speaker 122 and a display 134. The video processing apparatus 100 receives a control input (operation instruction) from a remote controller 163, and supplies the controller 150 with a control command corresponding to the operation instruction (control input).

The input module 111 is capable of receiving a digital broadcast signal which can be received via an antenna 101, for example, such as a digital terrestrial broadcast signal, a Broadcasting Satellite (BS) digital broadcast signal, and/or a communications satellite (CS) digital broadcast signal. The input module 111 is also capable of receiving content (external input) supplied via a set top box (STB), for example, or as a direct input.

The input module 111 performs tuning (channel tuning) of the received digital broadcast signal. The input module 111 supplies the tuned digital broadcast signal to the demodulator 112. As a matter of course, the external input made via an STB, for example, is directly supplied to the demodulator 112. The video processing apparatus 100 may comprise a plurality of input modules (tuners) 111. In that case, the video processing apparatus 100 is capable of receiving a plurality of digital broadcast signals/content simultaneously.

The demodulator 112 demodulates the tuned digital broadcast signal/content. That is, the demodulator 112 acquires moving image data (hereinafter referred to as a stream) such as a transport stream (TS) from the digital broadcast signal/content. The demodulator 112 inputs the acquired stream to the signal processor 113. The video processing apparatus 100 may comprise a plurality of demodulators 112. The plurality of demodulators 112 is capable of demodulating each of a plurality of digital broadcast signals/content.

As described above, the antenna 101, the input module 111, and the demodulator 112 function as reception means for receiving a stream.

The signal processor 113 performs signal processing such as a separation process on the stream. That is, the signal processor 113 separates a digital video signal, a digital audio signal, and other data signals, such as electronic program guides (EPGs) and text data formed of characters and codes called data-broadcast, from the stream. The signal processor 113 is capable of separating a plurality of streams demodulated by the plurality of demodulators 112.

The signal processor 113 supplies the audio processor 121 with the separated digital audio signal. Further, the signal processor 113 supplies the video processor 131 with the separated digital video signal. Further, the signal processor 113 supplies a data signal such as EPG data to the controller 150.

The signal processor 113 is capable of converting the stream into data (recording stream) in a recordable state on the basis of control by the controller 150. Further, the signal processor 113 is capable of supplying the storage 160 or other modules with a recording stream on the basis of control by the controller 150.

Moreover, the signal processor 113 is capable of converting (transcoding) a bit rate of the stream from a bit rate set originally (in the broadcast signal/content) into a different bit rate. That is, the signal processor 113 is capable of transcoding (converting) the original bit rate of the acquired broadcast signal/content into a bit rate lower than the original bit rate. Thereby, the signal processor 113 is capable of recording content (a program) with less capacity.

The audio processor 121 converts a digital audio signal received by the signal processor 113 into a signal (audio signal) in a format that can be reproduced by the speaker 122. That is, the audio processor 121 includes a digital-to-analog (D/A) converter, and converts the digital audio signal into an analog audio (acoustic sound)/speech signal. The audio processor 121 supplies the speaker 122 with the converted audio (acoustic sound)/speech signal. The speaker 122 reproduces the audio and the acoustic sound on the basis of the supplied audio (acoustic sound)/speech signal.

The video processor 131 converts the digital video signal from the signal processor 113 into a video signal in a format that can be reproduced by the display 134. That is, the video processor 131 decodes the digital video signal received from the signal processor 113 into a video signal in a format that can be reproduced by the display 134. The video processor 131 outputs the decoded video signal to the displaying processor 133.

An on-screen display (OSD) signal is generated by the OSD processor 132 for displaying graphical user interface (GUI) display, subtitle display, time display, icon/operation display (control key transmission) pattern, and the like, by superimposing such display on a display signal from the video processor 131, on the basis of a data signal supplied from the signal processor 113, and/or a control signal supplied from the controller 150.

The displaying processor 133 adjusts color, brightness, sharpness, contrast, or other image qualities of the received video signal on the basis of control by the controller 150, for example. The displaying processor 133 supplies the display 134 with the video signal subjected to image quality adjustment. The display 134 displays video on the basis of the supplied video signal.

Further, the displaying processor 133 superimposes a display signal from the video processor 134 subjected to the image quality adjustment on the OSD signal from the OSD processor 132, and supplies the superimposed signal to the display 134.

The display 134 includes a liquid crystal display panel including a plurality of pixels arranged in a matrix pattern and a liquid crystal display device including a backlight which illuminates the liquid crystal panel, for example. The display 134 displays video on the basis of the video signal supplied from the displaying processor 133.

The video processing apparatus 100 may be configured to include an output terminal which outputs a video signal, in place of the display 134. Further, the video processing apparatus 100 may be configured to include an output terminal which outputs an audio signal, in place of the speaker 122. Moreover, the video processing apparatus 100 may be configured to include an output terminal which outputs a digital video signal and a digital audio signal.

The controller 150 functions as control means for controlling an operation of each element of the video processing apparatus 100. The controller 150 includes a CPU 151, a ROM 152, a RAM 153, an EEPROM (non-volatile memory) 154, and the like. The controller 150 performs a variety of processes on the basis of an operation signal supplied from the operation input module 161.

The CPU 151 includes a computing element, for example, which performs a variety of computing operations. The CPU 151 embodies a variety of functions by performing programs stored in the ROM 152, the EEPROM 154, or the like.

The ROM 152 stores programs for controlling the video processing apparatus 100, and programs for embodying a variety of functions, and the like. The CPU 151 activates the programs stored in the ROM 152 on the basis of the operation signal supplied from the operation input module 161. Thereby, the controller 150 controls an operation of each element.

The RAM 153 functions as a work memory of the CPU 151. That is, the RAM 153 stores a result of computation by the CPU 151, data read by the CPU 151, and the like.

The EEPROM 154 is a non-volatile memory which stores a variety of setting information, programs, and the like.

The storage 160 includes a storage medium which stores content. The storage 160 is, for example, a hard disk drive (HDD), a solid-state drive (SSD), a semiconductor memory, or the like. The storage 160 is capable of storing a recorded stream, text data, and the like supplied from the signal processor 113.

The operation input module 161 includes an operation key, a touchpad, or the like, which generates an operation signal in response to an operation input from the user, for example. The operation input module 161 may be configured to receive an operation signal from a keyboard, a mouse, or other input devices capable of generating an operation signal. The operation input module 161 supplies the controller 150 with the operation signal.

A touchpad includes a device capable of generating positional information on the basis of a capacitance sensor, a thermo-sensor, or other systems. When the video processing apparatus 100 comprises the display 134, the operation input module 161 may be configured to include a touch panel formed integrally with the display 134.

The reception module 162 includes a sensor, for example, which receives an operation signal from the remote controller 163 supplied by an infrared (IR) system, for example. The reception module 162 supplies the controller 150 with the received signal. The controller 150 receives the signal supplied from the reception module 162, amplifies the received signal, and decodes the original operation signal transmitted from the remote controller 163 by performing analog-to-digital (A/D) conversion of the amplified signal.

The remote controller 163 generates an operation signal on the basis of an operation input from the user. The remote controller 163 transmits the generated operation signal to the reception module 162 via infrared communications. The reception module 162 and the remote controller 163 may be configured to transmit and receive an operation signal via other wireless communications using radio waves (RF), for example.

The local area network (LAN) interface 171 is capable of performing communications with other devices on the network 400 via the wireless communication terminal 300 by a LAN or a wireless LAN. Thereby, the video processing apparatus 100 is capable of performing communications with other devices connected to the wireless communication terminal 300. For example, the video processing apparatus 100 is capable of acquiring a stream recorded in a device on the network 400 via the LAN interface 171, and reproducing the acquired stream.

The wired communication module 173 is an interface which performs communications on the basis of standards such as HDMI and MHL. The wired communication module 173 includes an HDMI terminal, not shown, to which an HDMI cable or an MHL cable can be connected, an HDMI processor 174 configured to perform signal processing on the basis of the HDMI standard, and an MHL processor 175 configured to perform signal processing on the basis of the MHL standard.

A terminal of the MHL cable that is connected to the video processing apparatus 100 has a structure compatible with the HDMI cable. The MHL cable includes a resistance between terminals (detection terminals) that are not used for communications. The wired communication module 173 is capable of determining whether the MHL cable or the HDMI cable is connected to the HDMI terminal by applying a voltage to the detection terminal.

The video processing apparatus 100 is capable of receiving a stream output from a device (source apparatus) connected to the HDMI terminal of the wired communication module 173 and reproducing the received stream. Further, the video processing apparatus 100 is capable of outputting a stream to the device (sink apparatus) connected to the HDMI terminal of the wired communication module 173.

The controller 150 causes the signal processor 113 to input a stream received by the wired communication module 173. The signal processor 113 separates a digital video signal, a digital audio signal, and the like from the received stream. The signal processor 113 transmits the separated digital video signal to the video processor 131, and the separated digital audio signal to the audio processor 121. Thereby, the video processing apparatus 100 is capable of reproducing the stream received by the wired communication module 173.

The video processing apparatus 100 further comprises a power-supply section, not shown. The power-supply section receives power from a commercial power source, for example, via an AC adaptor, for example. The power-supply section converts the received alternating-current power into direct-current power, and supplies the converted power to each element of the video processing apparatus 100.

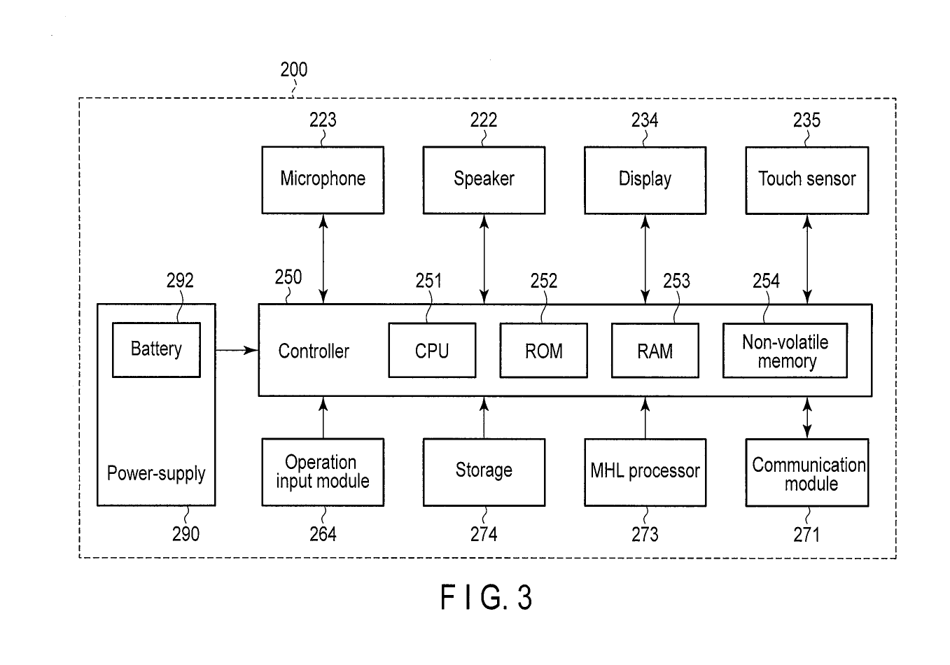

FIG. 3 is an exemplary diagram of the portable terminal 200.

The portable terminal (cooperating device) 200 comprises a controller 250, an operation input module 264, a communication module 271, an MHL processor 273, and a storage 274. Further, the portable terminal 200 comprises a speaker 222, a microphone 223, a display 234, and a touch sensor 235.

The controller 250 functions as a controller configured to control an operation of each element of the portable terminal 200. The controller 250 includes a CPU 251, a ROM 252, a RAM 253, a non-volatile memory 254, and the like. The controller 250 performs a variety of operations on the basis of an operation signal supplied from the operation input module 264 or the touch sensor 235. The controller 250 also performs control of each element corresponding to a control command supplied from the video processing apparatus 100 via the MHL cable 10, activation of an application, and a process (execution of the function) supplied by the application (which may be performed by the CPU 251).

The CPU 251 includes a computing element configured to execute a variety of computing operations. The CPU 251 embodies a variety of functions by executing programs stored in the ROM 252 or the non-volatile memory 254, for example.

The ROM 252 stores programs for controlling the portable terminal 200, programs for embodying a variety of functions, and the like. The CPU 251 activates the programs stored in the ROM 252 on the basis of an operation signal from the operation input module 264. Thereby, the controller 250 controls an operation of each element.

The RAM 253 functions as a work memory of the CPU 251. That is, the RAM 253 stores a result of computation by the CPU 251, data read by the CPU 251, and the like.

The non-volatile memory 254 is a non-volatile memory configured to store a variety of setting information, programs, and the like.

The controller 250 is capable of generating a video signal to be displayed on a variety of screens, for example, according to an application being executed by the CPU 251, and causes the display 234 to display the generated video signal. The display 234 reproduces moving images (graphics), still images, or character information on the basis of the supplied moving image signal (video).

The controller 250 is capable of generating an audio signal to be reproduced, such as various kinds of speech, according to the application being executed by the CPU 251, and causes the speaker 222 to output the generated speech signal. The speaker 222 reproduces sound (acoustic sound/speech) on the basis of a supplied audio signal (audio).

The microphone 223 collects sound in the periphery of the portable terminal 200, and generates an acoustic signal. The acoustic signal is converted into acoustic data by the controller 250 after analog-to-digital conversion, and is temporarily stored in the RAM 253. The acoustic data is converted into speech/acoustic sound (reproduced) by the speaker 222, after digital-to-analog conversion, as necessary. The acoustic data is used as a control command in a speech recognition process after analog-to-digital conversion.

The display 234 includes, for example, a liquid crystal display panel including a plurality of pixels arranged in a matrix pattern and a liquid crystal display device including a backlight which illuminates the liquid crystal panel. The display 234 displays video on the basis of a video signal.

The touch sensor 235 is a device configured to generate positional information on the basis of a capacitance sensor, a thermo-sensor, or other systems. The touch sensor 235 is provided integrally with the display 234, for example. Thereby, the touch sensor 235 is capable of generating an operation signal on the basis of an operation on a screen displayed on the display 234 and supplying the generated operation signal to the controller 250.

The operation input module 264 includes a key which generates an operation signal in response to an operation input from the user, for example. The operation input module 264 includes a volume adjustment key for adjusting the volume, a brightness adjustment key for adjusting the display brightness of the display 234, a power-supply key for switching (turning on/off) the power states of the portable terminal 200, and the like. The operation input module 264 may further comprise a trackball, for example, which causes the portable terminal 200 to perform a variety of selection operations. The operation input module 264 generates an operation signal according to an operation of the key, and supplies the controller 250 with the operation signal.

The operation input module 264 may be configured to receive an operation signal from a keyboard, a mouse, or other input devices capable of generating an operation signal. For example, when the portable terminal 200 includes a USB terminal or a module which embodies a Bluetooth (registered trademark) process, the operation input module 264 receives an operation signal from an input device connected via USB or Bluetooth, and supplies the received operation signal to the controller 250.

The communication module 271 is capable of performing communications with other devices on the network 400 via the wireless communication terminal 300, using a LAN or a wireless LAN. Further, the communication module 271 is capable of performing communications with other devices on the network 400 via a portable telephone network. Thereby, the portable terminal 200 is capable of performing communications with other devices connected to the wireless communication terminal 300. For example, the portable terminal 200 is capable of acquiring moving images, pictures, music data, and web content recorded in devices on the network 400 via the communication module 271 and reproducing the acquired content.

The MHL processor 273 is an interface which performs communications on the basis of the MHL standard. The MHL processor 273 performs signal processing on the basis of the MHL standard. The MHL processor 273 includes a USB terminal, not shown, to which an MHL cable can be connected.

The portable terminal 200 is capable of receiving a stream output from a device (source apparatus) connected to the USB terminal of the MHL processor 273, and reproducing the received stream. Further, the portable terminal 200 is capable of outputting a stream to a device (sink apparatus) connected to the USB terminal of the MHL processor 273.

Moreover, the MHL processor 273 is capable of generating a stream by superimposing a video signal to be displayed on a speech signal to be reproduced. That is, the MHL processor 273 is capable of generating a stream including video to be displayed on the display 234 and audio to be output from the speaker 222.

For example, the controller 250 supplies the MHL processor 273 with a video signal to be displayed and an audio signal to be reproduced, when an MHL cable is connected to the USB terminal of the MHL processor 273 and the portable terminal 200 operates as a source apparatus. The MHL processor 273 is capable of generating a stream in a variety of formats (for example, 1080i and 60 Hz) using the video signal to be displayed and the audio signal to be reproduced. That is, the portable terminal 200 is capable of converting a display screen to be displayed on the display 234 and audio to be reproduced by the speaker 222 into a stream. The controller 250 is capable of outputting the generated stream to the sink apparatus connected to the USB terminal.

The portable terminal 200 further comprises a power-supply 290. The power-supply 290 includes a battery 292, and a terminal (such as a DC jack) for connecting to an adaptor which receives power from a commercial power source, for example. The power-supply 290 charges the battery 292 with the power received from the commercial power source. Further, the power-supply 290 supplies each element of the portable terminal 200 with the power stored in the battery 292.

The storage 274 includes a hard disk drive (HDD), a solid-state drive (SSD), a semiconductor memory, and the like. The storage 274 is capable of storing content such as programs, applications, moving images that are executed by the CPU 251 of the controller 250, a variety of data, and the like.

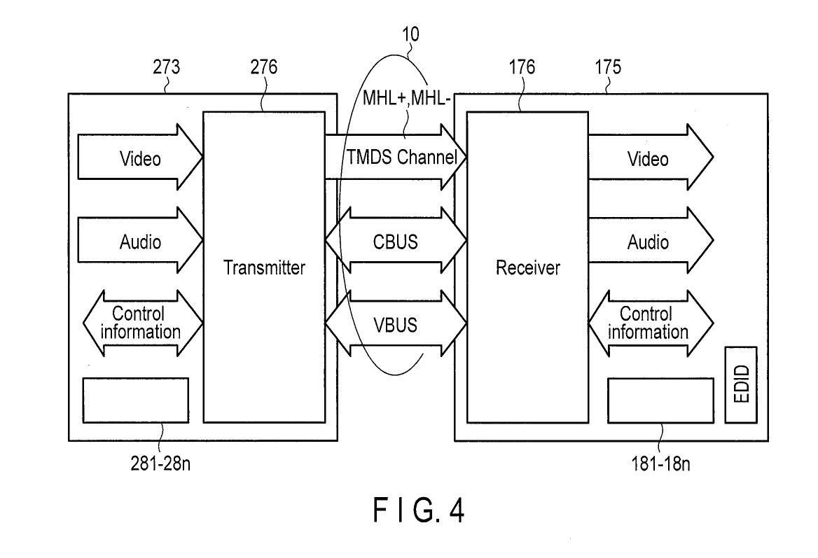

FIG. 4 is an exemplary diagram illustrating mutual communications between the electronic devices based on the MHL standard. In FIG. 4, the portable terminal 200 is a source apparatus, and the video processing apparatus 100 is a sink apparatus, for example.

The MHL processor 273 of the portable terminal 200 includes a transmitter 276 and a receiver, not shown. The MHL processor 175 of the video processing apparatus 100 includes a transmitter, not shown, and a receiver 176.

The transmitter 276 and the receiver 176 are connected via the MHL cable 10.

When a Micro-USB terminal is applied as a connector at the time of implementation, the MHL cable is formed of the following 5 lines: a VBUS (power) line; an MHL− (differential pair [− (negative)] line; an MHL+ (differential pair [+ (positive)] line; a CBUS (control signal) line, and a GND (ground) line.

The VBUS line supplies power from the sink apparatus to the source apparatus (functions as a power line). That is, in the connection of FIG. 4, the sink apparatus (power supplying source [video processing apparatus 100]) supplies the source apparatus (portable terminal 200) with power of +5V via the VBUS line. Thereby, the sink apparatus is capable of operating using the power supplied from the sink apparatus (via the VBUS line). The portable terminal 200 as the source apparatus operates using power supplied from the battery 292, during independent operation. When the portable terminal 200 is connected to the sink apparatus via the MHL cable 10, on the other hand, the battery 292 can be charged with the power supplied via the VBUS line from the sink apparatus.

The CBUS line is used for bi-directionally transmitting a Display Data Channel (DDC) command, an MHL sideband channel (MSC) command, or an arbitrary control key, for example.

A DDC command is used for reading of data (information) stored in extended display identification data (EDID), which is information set in advance for notifying the counterpart apparatus of a specification (display ability) in a display, and recognition of High-bandwidth Digital Content Protection (HDCP), which is a system for encrypting a signal transmitted between the apparatuses, for example.

The MSC command or the arbitrary control key are used for reading/writing a variety of resistors 181-18m (where m is an integer) and a variety of resistors 281-28n (where n is an integer), controlling such resisters by remote control, for example, by transmitting (supplying) a control key from the counterpart device to the device of interest using a remote controller, and the like.

As described above, the video processing apparatus 100 as the sink apparatus outputs a predetermined control command to the portable terminal 200 as a source apparatus via the CBUS line. The portable terminal 200 is capable of performing a variety of operations in response to a received command or a control key.

That is, the source apparatus is capable of performing HDCP recognition between the source apparatus and the sink apparatus and reading the EDID from the sink apparatus by transmitting a DDC command to the sink apparatus. Further, the video processing apparatus 100 and the portable terminal 200 transmit and receive a key, for example, in a procedure compliant with the HDCP, and perform mutual recognition.

When the source apparatus (portable terminal 200) and the sink apparatus (video processing apparatus 100) are recognized by each other, the source apparatus and the sink apparatus are capable of transmitting and receiving encrypted signals to and from each other. The portable terminal 200 reads the EDID from the video processing apparatus 100 in the midst of HDCP recognition with the video processing apparatus 100. Reading (acquisition) of the EDID may be performed at independent timing different from that of HDCP recognition.

The portable terminal 200 analyzes the EDID acquired from the video processing apparatus 100, and recognizes display information indicating a format including a resolution, a color depth, a transmission frequency, and the like that can be processed by the video processing apparatus 100. The portable terminal 200 generates a stream in a format including a resolution, a color depth, a transmission frequency, and the like that can be processed by the video processing apparatus 100.

The MHL+ and the MHL− are lines for transmitting data. The two lines of MHL+ and the MHL− function as a twist pair. For example, the MHL+ and the MHL-function as a transition minimized differential signaling (TMDS) channel which transmits data in the TMDS system. Further, the MHL+ and the MHL− are capable of transmitting a synchronization signal (MHL clock) in the TMDS system.

For example, the source apparatus is capable of outputting a stream to the sink apparatus via the TMDS channel. That is, the portable terminal 200 which functions as the source apparatus is capable of transmitting a stream obtained by converting video (display screen) to be displayed on the display 234 and the audio to be output from the speaker 222 to the video processing apparatus 100 as the sink apparatus. The video processing apparatus 100 receives the stream transmitted using the TMDS channel, performs signal processing of the received stream, and reproduces the stream.

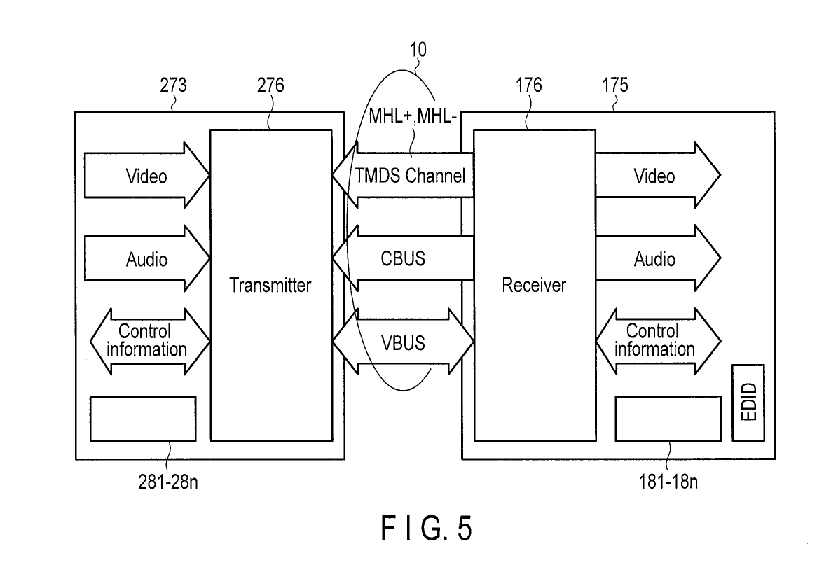

FIG. 5 is an exemplary diagram of the embodiment applied to mutual communications between the electronic apparatuses shown in FIG. 4. FIG. 5 shows an example of a control signal (control key) that is supplied from the video processing apparatus 100 to the portable terminal 200.

FIG. 5 is an exemplary diagram of the embodiment applied to mutual communications between the electronic apparatuses shown in FIG. 4.

In the embodiment shown in FIG. 5, an MSC command or an arbitrary control key (control command) is supplied from the video processing apparatus 100 to the portable terminal 200 via the CBUS line.

In the embodiment shown in FIG. 5, an MSC command is supplied from the video processing apparatus 100 to the portable terminal 200 via the CBUS line. Further, names of applications stored in the portable terminal 200 (and MHL-compatible information of each application) can be read (acquired) from the video processing apparatus 100. It is to be noted that the HDCP recognition and EDID acquisition described with reference to FIG. 4 have been completed before the control command (MSC command) is supplied (transmitted) and the MHL-compatible information is read (acquired).

For example, a variety of control keys called pass-throughs, which are generated according to a control instruction to the portable terminal 200, i.e., an operation of the remote controller 163 attached to the video processing apparatus 100, are supplied (transmitted) to the portable terminal 200. It is to be noted that the HDCP recognition and the EDID acquisition described with reference to FIG. 4 have been completed before the control keys are supplied (transmitted).

When the video processing apparatus 100 is operated by remote control and a control key for controlling an operation of the counterpart device, i.e., the portable terminal (cooperating device) 200 as the sink apparatus, is transmitted, there are cases where the control key does not reach the portable terminal 200 or a problem caused by the MHL cable 10 occurs, for some reason.

For example, when the user operates the remote controller 163 attached to the video processing apparatus 100 in order to transmit a control key for causing the video processing apparatus 100 to reproduce content being reproduced in the portable terminal 200 to the portable terminal 200, there are cases where the portable terminal 200 is in a non-reactive state, in which the portable terminal 200 makes no reaction (response).

Depending on the type of application stored in the portable terminal (cooperating device) 200, there are cases where an application cannot be activated or controlled using a control command that is received by the video processing apparatus (control device) 100 connected to the MHL cable 10 via the remote controller 163 of the video processing apparatus 100 and is supplied from the video processing apparatus 100 to the portable terminal 200. Under the current conditions, however, it is possible to recognize such a case only after an event occurs that the portable terminal 200 makes no reaction (response) (the portable terminal 200 is in a non-responsive state) when the user operates the remote controller 163 (of the video processing apparatus 100) so as to control the portable terminal 200 connected via the MHL cable 10 and transmit a control command (to the portable terminal device 200), for example. That is, even when an application stored in the portable terminal 200 cannot be executed (controlled) by the remote controller 163 of the video processing apparatus 100 connected via the MHL cable 10, there are cases where it is impossible to determine that the application is incompatible with the MHL standard until a result of operation of the remote controller 163 is recognized.

In such a case, it is necessary to identify causes for a variety of non-reactive factors, for example, a control key not having been transmitted (a control key has not been transmitted because of a problem with the remote controller), the portable terminal 200 making no reaction in spite of a control key having been transmitted (a problem has occurred in the portable terminal 200), and a connection problem having occurred in connection of the MHL cable 10 (there is no problem with the portable terminal 200 or the video processing apparatus 100). Such non-reactive factors can occur when a cooperating (pass-through) setting (transmission of a control key indicating a control instruction to the portable terminal 200) is not made (disabled), or when a control key not corresponding to the portable terminal 200 has been transmitted.

It is therefore necessary for the user to determine the reason why the application does not operate or cannot be controlled because of a non-reactive factor after operating the remote controller 163. When the application does not operate/cannot be controlled because of a non-reactive factor, it is necessary to consider various factors, for example, a control command not having been transmitted (a control command has not been transmitted because of a problem with the remote controller), the portable terminal 200 being non-reactive in spite of a control command having been transmitted (a problem has occurred in the portable terminal 200), a connection problem having occurred in the MHL cable 10 (there is no problem with the portable terminal 200 or the video processing apparatus 100), or an application being incompatible with the MHL standard.

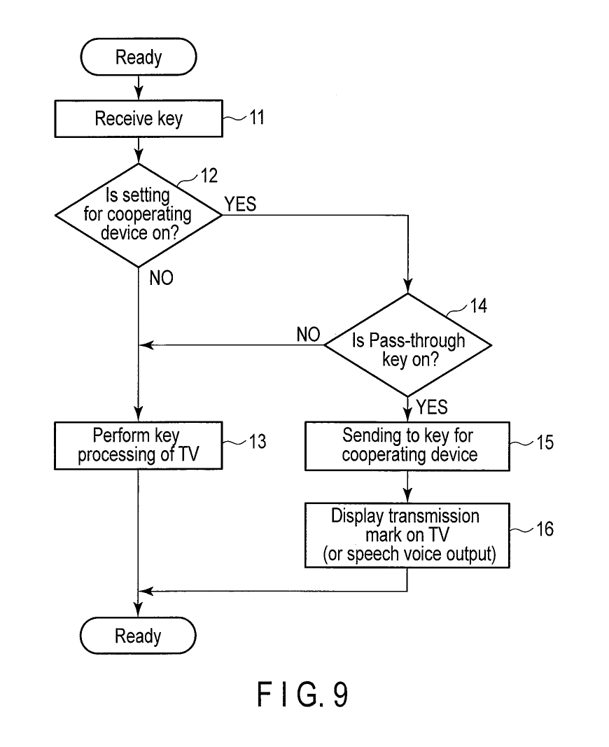

In view of the above-described background, the present embodiment is configured such that the portable terminal 200 and the video processing apparatus 100 are connected via the MHL cable 10 and information compatible with the MHL standard, for example, on each application stored in the device of interest (portable terminal 200) is transmitted from the portable terminal 200 to the video processing apparatus 100 at predetermined timing after the video processing apparatus 100 has finished recognizing the portable terminal 200 as shown in FIG. 4. Thereby, it is possible to notify the user of an application incompatible with MHL, as will be described later with reference to FIGS. 9, 10 and 13.

It is necessary to consider the case where the information compliant with MHL cannot be acquired from an application stored in (installed in) the portable terminal 200 (the application does not contain information compliant with the MHL standard, or information compliant with the MHL standard is not attached to the application). In that case, it is possible to cause the video processing apparatus 100, for example, to acquire information compliant with the MHL standard from an application supply source (application distributor) via the network 400 or a cloud service, or a server which manages downloading and charging of applications. Further, the acquired information compatible with the MHL standard can be stored in the EEPROM 154, for example.

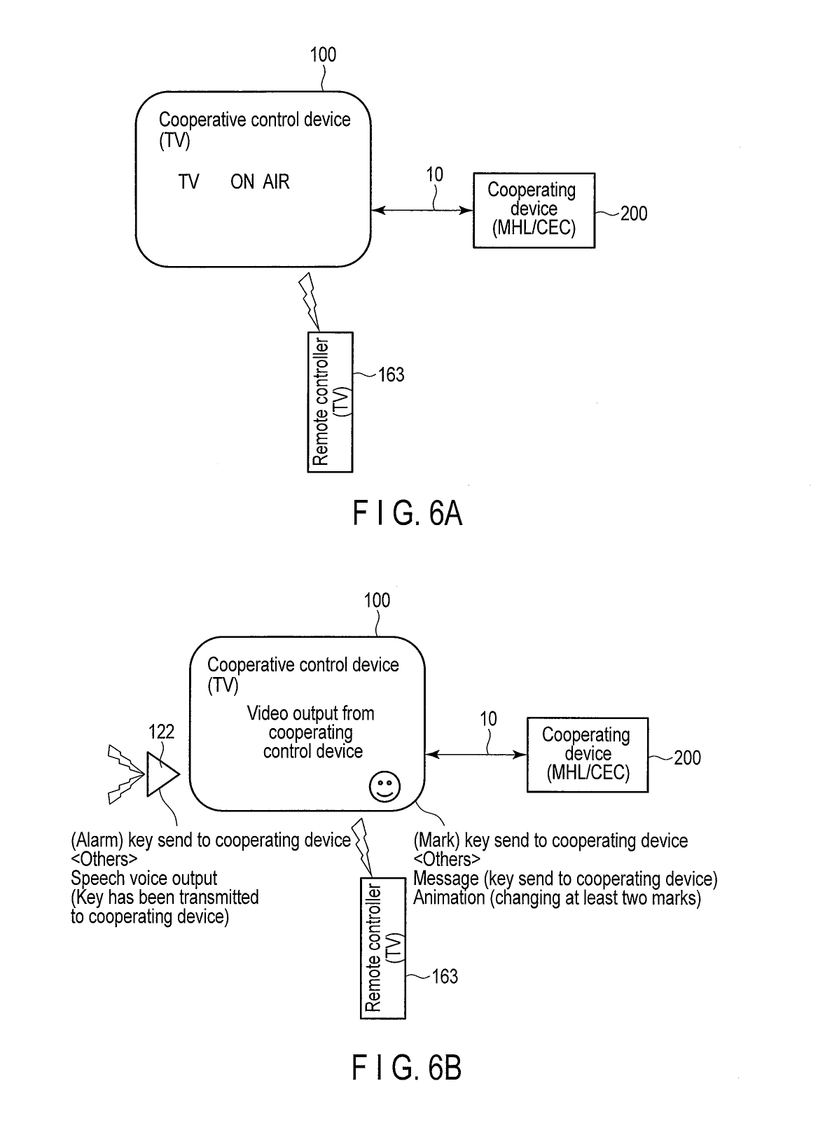

FIGS. 6A and 6B are exemplary diagrams of the embodiment.

When the user transmits a control key to the portable terminal 200 connected to the television device 100 via the MHL cable 10 by operating the remote controller 163 attached to the video processing apparatus 100, for example, while the video processing apparatus (television device) 100 is reproducing content (a program), as shown in FIG. 6A, a discrimination image such as an icon display signal indicating that the control key has been transmitted, or a display signal based on which an animation image can be reproduced, is superimposed on a video signal supplied to the display 134 from the displaying processor 133, as an OSD signal from the OSD processor 132, as shown in FIG. 6B. The display signal may be a character string such as “A control key has been transmitted”.

Thereby, screen display (image) making a notification (display) that a control key corresponding to the operation of the remote controller 163 by the user has been transmitted to the portable terminal 200 is displayed on the display 134 of the video processing apparatus 100. Therefore, the user is capable of recognizing that a control key corresponding to the operation of the remote controller 163 by the user has been transmitted to the portable terminal 200.

It is also possible to perform a notification by acoustic sound output, such as guide alarm (operation sound), chime, or melody, or by acoustic sound output, such as “A control key has been transmitted” from the speaker 122, independently from the image (screen display) shown in FIG. 6B or in parallel thereto.

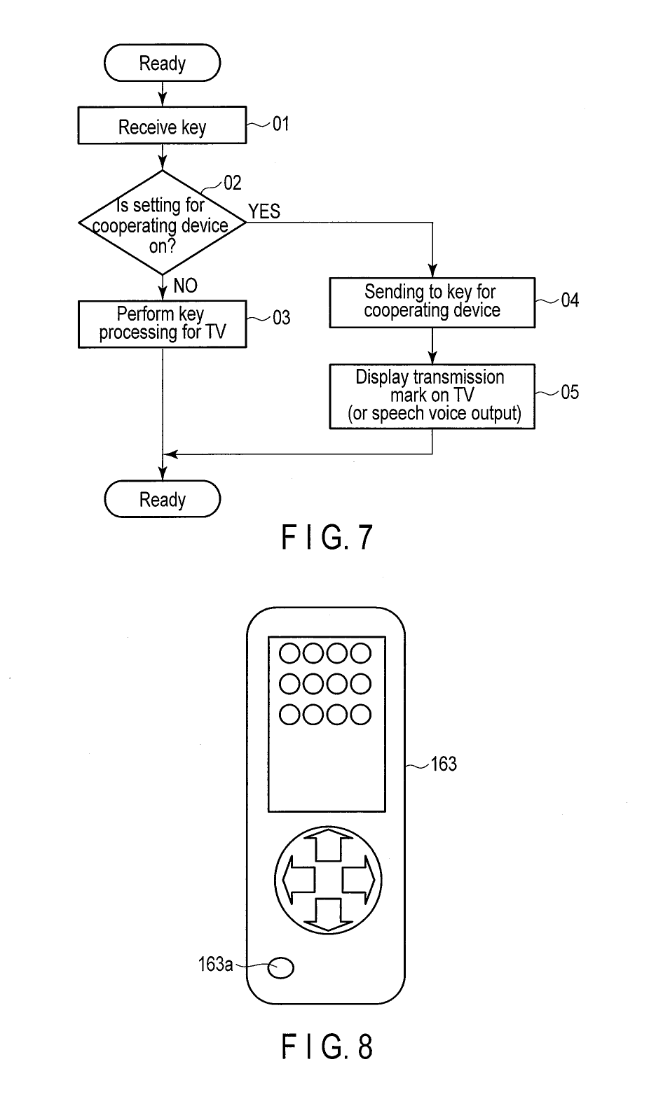

FIG. 7 shows an exemplary procedure embodying the notification (display) shown in FIG. 6 at the level of software.

When the user instructs the television apparatus (video processing apparatus) 100 to transmit a control key to the portable terminal (cooperating device) 200 via the remote controller and the television apparatus 100 receives an operation instruction (key) from the remote controller [01], the television apparatus 100 checks whether a cooperating (pass-through) setting is enabled or disabled [02].

When the cooperating setting is disabled (turned off) [02—NO], the television apparatus 100 determines that an input of a control key from the remote controller (an instruction from the remote controller) is an input to the television apparatus 100, and performs a process (operation) corresponding to the input control key [03]. A disabled state of the cooperating setting corresponds to the case where a cooperating setting switch or button provided on the remote controller 163 is turned off, or the case where the cooperating setting is disabled (turned off) in a setting screen from the menu screen.

When the cooperating (pass-through) setting is enabled (turned on) [02—YES], the television apparatus 100 determines that an input of a control key from the remote controller (instruction from the remote controller) is an input to the portable terminal (cooperating device) 200 and transmits (transfers) the control key to the portable terminal 200 [04].

At the same time, or at predetermined timing, a screen display (image) making a notification that the control key described with reference to FIG. 6B has been transmitted is displayed on the display 134 of the television apparatus 100 [05]. As described above, it is also possible to make a notification by acoustic sound output or speech output, together with display of the screen display (image). Further, as described above, the notification that the control key has been transmitted may be performed merely by acoustic sound output or speech output.

FIG. 8 illustrates an exemplary configuration of a remote controller which improves user operability in the cooperating setting shown in FIG. 6B.

By providing a pass-through button/key 163a, for example, on the remote controller 163 as shown in FIG. 8, it is possible for the user to discriminate between an instruction input to the video processing apparatus 100 and an instruction input to the portable terminal 200, at the point in time when the instruction input is made from the remote controller 163, as the button/key 163a is turned on/off. It is possible to notify the user of information as to whether the cooperating setting is enabled or disabled by configuring the pass-through button/key 163a as a light-emitting type including an illumination mechanism in the button/key and configured to emit light when the pass-through button/key 163a is turned on, for example.

FIG. 9 illustrates an exemplary procedure for embodying a notification (display) of a cooperating setting in which a remote controller capable of making a notification as to whether the cooperating setting shown in FIG. 8 is enabled or disabled, at the level of software.

When the user instructs the television apparatus (video processing apparatus) 100 to transmit a control key to the portable terminal (cooperating device) 200 via the remote controller and the television apparatus 100 receives an operation instruction (key) from the remote controller [11], the television apparatus 100 checks whether the cooperating (pass-through) setting is enabled or disabled [12].

When the cooperating is disabled (turned off) [12—NO], the television apparatus 100 determines that an input of the control key from the remote controller (instruction from the remote controller) is an input to the television apparatus 100, and performs a process (operation) corresponding to the input control key [13]. A disabled state of the cooperating setting corresponds to the case where the cooperating setting switch or button provided on the remote controller 163 is turned off, or the case where the cooperating setting is disabled (turned off) in a setting screen from the menu screen, for example.

When the cooperating (pass-through) setting is enabled (turned on) [12—YES], the television apparatus 100 determines whether the pass-through button/key 163a is turned on in the remote controller 163 [14].

When the pass-through button/key 163a is not turned on [14—NO], the television apparatus 100 determines that an input of the control key from the remote controller (instruction from the remote controller) is an input to the television apparatus 100, and performs a process (operation) corresponding to the input control key [13].

When the pass-through button/key 163a is turned on [14—YES], the television apparatus 100 determines that an input of the control key from the remote controller (instruction from the remote controller) is an input to the portable terminal 200, and transmits (transfers) the control key to the portable terminal 200 [15].

At the same time, or at predetermined timing, a screen display (image) which makes a notification that the control key described with reference to FIG. 6B has been transmitted is displayed on the display 134 of the television apparatus 100 [16]. As described above, it is also possible to make the notification by acoustic output or speech output together with display of the screen display (image). Further, as described above, the notification that the control key has been transmitted may be performed merely by acoustic output or speech output.

By providing the pass-through button/key 163a shown in FIG. 8, it is possible to select (change) a device which is operated by the remote controller (to which a control key is transmitted) during operation (control input) of the remote controller, as necessary, regardless of whether the pass-through (cooperating) setting is enabled or disabled in setting from the menu screen, for example. Thereby, user-friendliness is improved. That is, it is advantageous to provide the pass-through button/key 163a in temporarily controlling the operation of the television apparatus 100 when a control input is made by some of the keys or the pass-through (cooperating) setting is enabled, regardless of on/off setting of the cooperating device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments. The accompanying claims and their equivalents are intended to cover such forms or modifications as would fall within the scope and spirit of the inventions.

What is claimed is:

1. An electronic device comprising:
a control signal receiving module configured to receive a control key corresponding to an instruction input;
a control signal determining module configured to determine that the control key received by the control signal receiving module is a control key to a connected device;
a transfer control module configured to transfer the control key about which the control signal determining module has made determination to the connected device; and
a displaying control module configured to output a display signal which indicates that the transfer control module transfers the control key to the connected device.

2. The electronic device of claim 1, further comprising:
a cooperating setting discriminating module configured to hold a setting to transfer the control key received by the control signal receiving module to the connected device.

3. The electronic device of claim 2, wherein the cooperating setting discriminating module includes an input module provided independently from an instruction input generator.

4. The electronic device of claim 1, further comprising:
a cooperating setting notification module configured to make a notification that the control key received by the control signal receiving module is transferred to the connected device by acoustic output or speech output.

5. The electronic device of claim 4, further comprising:
a cooperating setting distinguishing module configured to hold a setting to transfer the control key received by the control signal receiving module to the connected device.

6. The electronic device of claim 5, wherein the cooperating setting distinguishing module includes an input module provided independently from the instruction input generator.

7. A method for controlling an electronic device comprising:
receiving a control key corresponding to an instruction input;
determining that the received control key is a control key to a connected device;
transferring the control key about which the determination has been made to the connected device; and
outputting a displaying signal which indicates that the control key is transferred to the connected device.

8. The method of claim 7, further comprising:
performing setting discrimination which can be referred to for determination by holding an enabled state of a setting to transfer the control key to the connected module.

9. The method of claim 7, wherein the setting discrimination is performed according to an input provided independently.
